(19) United States
(12) Patent Application Publication
(10) Pub. No.: US 2003/0009536 A1
(43) Pub. Date: Jan. 9, 2003

(54) Method and system for collaborative knowledge management

(75) Inventors: Charles English Henderson, Lexington, VA (US); Omid Ebrahimi Kia, North Bethesda, MD (US)

Correspondence Address: Mr. C. Gregory Earls, US Technologies Inc., 1130 Connecticut Avenue, NW, Suite 700, Washington, DC, 20036, US

(73) Assignee: Portris, Inc., Washington, DC

(21) Appl. No.: 09/899,534

(22) Filed: Jul. 6, 2001

(51) Int. Cl. G06F 15/16

(52) U.S. Cl. 709/219; 709/203

(57) ABSTRACT

A collaborative knowledge management system (CKMS) includes application interfaces collecting data objects from and providing data objects to respective application programs including, for example, word processing, spreadsheet, graphics, e-mail, general ledger, ERP and other programs and utilities. The data objects are associated with respective relationships identifying other data objects, applications and users (whereby users include, but are not limited to people, machines and software). A set of rules defines how the data objects are to react to various systems states and actions of the objects of the relationships. Objects may be stored in a common format, or lingua franca, so that diverse applications and users may form, share and interrelate knowledge provided by the data objects and collaborate in the creation of new data objects and define new relationships.

### FIELD OF THE INVENTION

The present invention relates to computerized database systems, more particularly, to a data network and system supporting collaboration and knowledge sharing; and the exchange of information between computer applications.

### BACKGROUND OF THE INVENTION

Systems and methods generally directed to collaboration, knowledge management and groupware systems are known. Internet chat rooms are an example of a collaboration system whereby, using Internet connectivity schemes (mostly internet browsers such as Netscape Navigator or Microsoft Internet Explorer), people (or “users”) log on to a specific site and start a virtual conversation by typing in a designated text box. The chat room program then takes input from the text boxes for all of the people that are logged on to that particular room and displays the typed content with the logged on username. This is similar to conference calling using a telephone, except that instead of a voice that is unique to an individual the conference is conducted with textual characters and username tags as unique identifiers. This type of collaboration is known as a non-moderated collaboration.

Moderated collaboration is also possible within the context of chat rooms with the difference that someone is designated as a moderator. Such implementations are common in distance learning systems. Systems that have been designed with these types of collaborations are collaborative whiteboards, application sharing and desktop sharing. The common idea to all collaboration, knowledge management and groupware systems is that a group of networked users can observe each other's actions and allow for possible collaboration. The problems that are apparent in this type of collaboration are non-scalability and non-retrievability. Non-scalability implies that the collaboration scheme breaks down if a large number of users were to participate in such an event. Non-retrievability means that if collaboration is achieved, and something is done as the result of the work of a collective group, then the process that attained the results is lost and cannot be recalled at a later date if it is not saved in an independent application.

Another knowledge management system is implemented by employing a shared drive technology whereby a networked computer sets aside a portion of its storage capability and stores data that is usable by others on the network in a way that can be browsed and/or searched. The knowledge component of these shared drives is derived from the capability to browse or search by way of automated machine-based knowledge understanding. For example, such a system is the World Wide Web search engines where the engines scour the network and automatically builds a database that contains representative signatures of the content available in the Internet. The search engines then use matching techniques to match the content signature to what the user needs to find.

Another well known Groupware system is based on the sharing of calendars, contact information and emails. The context of groupware is a collaborative knowledge management that operates on a well-defined context. Calendars and contact information sharing provides this strict context and allows for collaboration along with storage capability that is well suited for browsing and searching. Applications such as Microsoft Outlook in combination with the Microsoft Exchange Back Office implement such schemes. The difficulty is that unstructured data does not fit into this model and current implementation relies on the a priori knowledge of the data format, which must be well defined and follow strict guidelines.

Accordingly, a need exists for a system and method that supports collaboration, knowledge management and Information Technology application integration between and among distributed users (including but not limited to people, machines and software) of structured and unstructured data across multiple platforms, applications, and data types.

### SUMMARY OF THE INVENTION

It is an object of this invention to provide a method and system to enable users to create and share media content in a distributed collaborative environment.

It is another object of this invention to provide a method and system to provide access to media content in a knowledge management platform.

It is another object of this invention to provide access to media content in an application program that might have been created in another application program.

It is another object of this invention to update media content, create new versions thereof and make new versions available to users that have used the previous version.

It is yet another object of this invention to implement a collaborative knowledge management system seamlessly so as to enable knowledge driven applications.

It is still another object of this invention to provide search capability across media content and relations to other media content.

It is yet another object of the invention to organize raw data to represent media content and relations to other media content.

It is again another object of this invention to disassociate media content from the application program in which it was created.

It is again yet another object of this invention to track user interaction with the application content.

The foregoing objects may be achieved by a method and system of the present invention used to manage media content for a distributed collaborative platform and implementation of a knowledge management system.

According to one aspect of the invention, a collaboration and knowledge management system may include an application interface configured to identify a data object selected by an application program. A session manager may receive and buffer the data object which is supplied to a server connected to the session manager. The server may be configured to define a set of relationships associated with the object. A database may be configured to restore and retrieve the object together with the relationships. The relationships may be associated with a set of rules used to define corresponding user privileges and application related information associated with the data object.

According to another aspect of the invention, a collaborative knowledge management system (“CKMS”) may include, an object managing platform, and a plurality of application interfaces, each providing respective application-specific Data Units. An engine (e.g., a processor acting as a server) may be configured to uniquely identify an addressable component within each of the Data Units wherein each of the addressable data components is self-describing including a type consistent with a schema corresponding to the respective Data Units. A database may store the schema and the data components according to a structure defined by an intermediate language (e.g., XML). A plurality of representations across multiple application-specific data units enable cross-application relationships.

According to another aspect of the invention, the collaborative knowledge management system may include a client that contains routines to circumvent the user application's commands and local storage and transmits and receives events and content to its server counterpart. The CKMS may also include a server, which interacts with the client in a unified fashion to allow content and relationship storage. The client may be integrated into applications via a seamless layer in such a way that it interacts with an enterprise based system which serves a Virtual Document. The enterprise system may then be available to all knowledge workers and may provide a central point of exchange of information, collaboration and knowledge store. The client may capture events that relate to content management and send them to the server, which in turn processes events and data and serves content and events to enabled applications. The server also may implement search and data organization methods to allow real time or near real time service and searches based on content and their relationships.

A CKMS, according to the invention, may take into consideration, and allow for, the creation and cross-referencing of content that supports a decision making process. Content that has been referenced by other content contains some level of cognitive action and therefore contains information about its raw data form and is therefore able to support a decision making process. The basis of this support is the capability to create relations between elements in the understanding hierarchy and keep these relationships in a way that can be shared by others. This not only scales to save mass amounts of creative content but also allows a large number of people to collaborate and users to exchange information.

To create context and keep relevant data, the present invention provides an infrastructure that can infer relationships. This entails a process that creates virtual files with relations to existing content and creates additional content based on a knowledge repository. For concurrent users, this content may be distributed and managed by a process that allows scalable collaboration and information exchange. This may be done by creating virtual files that contain only relational pointers, which is served from a database server. The database is then able to implement scalable concurrency and allows for a search mechanism that not only searches content but also allows relational searches.

A CKMS according to the invention may integrate application programs, such as those included in Microsoft Office Suite (e.g., Word, Powerpoint, Excel, Outlook, and Internet Explorer) as a front end to the front office and ERP (Enterprise Resource Planning), General Ledger, OSS/BSS (Operations System Software and Billing System Software) and CRM (Content Resource Management) as a front end to the back office. These sets of programs are not the only programs that may be supported by a CKMS according to the invention but are accepted and widely used. Of course, other applications having an appropriate API (Application Program Interface), or the ability to read and write in a widely used data format may also be supported by a CKMS according to the invention.

Integration of application programs into the CKMS may circumvent local data representation and instead routes the data through to a central, distributed or local (e.g., PC hard drive) relational database. For example, circumvention of data representation and support for custom functions in Microsoft Office is available through the Microsoft Office API toolkit. After intercepting custom events and calling custom routines, a universal data representation capability may be defined so that content created by one application can be shared across a variety of other applications (e.g., Word, PowerPoint, Excel, ERP, General Ledger and CRM). According to a preferred implementation of the CKMS, this representation is supported by XML (extensible Markup Language). Although XML is only a descriptive language and does not normally contain relations even in the content level, it serves as an intermediate representation so that a universal content description is available to the relational database. The XML, or any intermediate data represented content, may then be divided and translated into a Lingua Franca and represented in a database by a combination of base content and relationships.

There exist several types of content and relationships that are abstracted out as basic content and relationships. Use of a relational database and session manager to interface with a user profile allows the CKMS to provide enhanced security services, team/task management and versioning. Referring to FIG. 1, application programs such as Microsoft Office Suite may be augmented by other applications. The CKMS Enabler, in the form of application interface 103, adds functionality to the applications and serves as client architecture to the CKMS Server 105. Before interacting with the CKMS server, the session manager 104 keeps track of users and content being used. The CKMS server 105 keeps track of contents and relations and is available to accept new content and relations as well as push changed content and relationships to clients.

To provide a complete understanding of the invention, the following definitions and explanations are provided.

Media content is described as the compilation of “raw data” within the descriptive domain of a “context”. Media implies the existence of any arbitrary type of data such as textual, image, video, audio or user defined type. Media content then generalizes the containment of data within a defined context, which in front office applications embodies data representations such as, for example in Excel or Powerpoint applications and in back office applications such as, for example in OSS/BSS or the General Ledger applications. Raw data is the foundation of content and context is implemented within a specific application and augments the raw data. Therefore, media content is usually defined within the realm of a single application. Some media content, such as HTML (HyperText Markup Language) or word-processing documents can be utilized by a number of applications; however, they still describe a single instance of media type and a similar description of raw data. A container that holds references to content and its representation is analogous to an application specific file. The CKMS may abstract content, description and related material from knowledge applications and may add knowledge capture utilities such as relationships between content and content attachment. CKMS may use containers to embody contents within a single presentation module. CKMS may also relate content to form pockets of knowledge, which can vary in size and importance. Therefore, a pocket of knowledge, which is the concentric storage of individual data unit, is application independent and can be used across a variety of applications for a variety of uses. CKMS may abstract and use content as data, MIME (simulating application behavior and originally used for email as the Multipurpose Internet Mail Extensions), relation and profile (i.e., user, date, and other metadata) objects to implement the end result.

Data objects, also referred to herein as Data Units and, at times, sections and content, are the smallest addressable unit of media content. Data objects are standardized to provide a set of primitive data that is necessary to construct all possible content. Data objects contain raw data, data descriptors and all related data that can create any type of application specific content. Data objects may contain any arbitrary data types. Data descriptors contain all context and formatting information. Use of a content across different containers may result in multiple data description sections.

Mime objects are the smallest addressable unit of media content that is not supported by the CKMS' Lingua Franca. The mime data contains the application specific data that is self contained in its entirety. The mime objects support versioning and can be inter-related, however, they can not be decomposed into constituent data objects.

Relational objects are pointers across data or mime objects and they infer all meaning within the store of managed data. The relation objects implement the knowledge structure for the information object and the Virtual Document as a whole. The relation objects also implement the data organization of the server entity which provides the enabling technology for the knowledge repository.

Metadata objects store all possible relevant data associated with the data, mime and relational objects. All possible data types that do not contribute to the content but to content management are reflected in the metadata, such as author, editor, time used, and other non-application related data.

Application interface is the integration of added functionality; event capture, event processing and control of applications that perform stand alone operations. These are stand alone applications in a sense that they only integrate with other applications via the computer's local storage. By adding application interfaces, we enable these applications to not only perform legacy operations but also interface with other applications and services in a client-server relation. The client-server relationship is one where clients can spawn events and poll servers to get needed services and data to fully implement their user interfaces.

A Network is a distributed communication system of computers that are connected by various hardware communication links and integrated into the operating system of the computer via various layered software components in a standard manner so that it is available for use by other software.

Exchange of information is an infrastructure where information is accessible, searchable and can be archived for a suite of applications. It also allows for containment of other data within a container as live data object threads through the knowledge fiber.

Collaboration is a method where groups of individuals team together to collectively perform work in a timely manner. It performs activity management so that there exists little or no overlap in the work done across the group members.

Knowledge is the formulation of a higher understanding as a result of performing some work. The invention uses networked computers as a tool to collaborate, save, retrieve, form and share knowledge as it is formed within the appropriate software applications.

### BRIEF DESCRIPTION OF DRAWINGS

The drawing figures depict the present invention by way of example, not by way of limitations. In the figures, like reference numerals refer to the same or similar elements.

FIG. 1 is a simplified block diagram of Collaborative Knowledge Management System (CKMS).

FIG. 2 is a block diagram of an application integration module of a CKMS according to the invention.

FIG. 3 is a block diagram of an application client of a CKMS according to the invention.

FIG. 4 is a block diagram of a session manager of a CKMS according to the invention.

FIG. 5 is a block diagram of a server of a CKMS according to the invention.

FIG. 6 is a diagram showing users collaborating on a single active Virtual Document using a CKMS.

FIG. 7 is an illustration of a screen shot of a word processor enabled by a CKMS.

FIG. 8 is a diagram depicting a process for mapping application data unit schema into data descriptor objects so as to ultimately form a representation of knowledge relationships.

FIG. 9 is a logic diagram showing steps required to save a disk file.

FIG. 10 is a logic diagram showing a process for editing a CKMS container.

FIG. 11 is a flowchart of a process for editing a CKMS container.

FIG. 12 is a flow diagram of a process for adding a CKMS container.

### DETAILED DESCRIPTION OF THE INVENTION

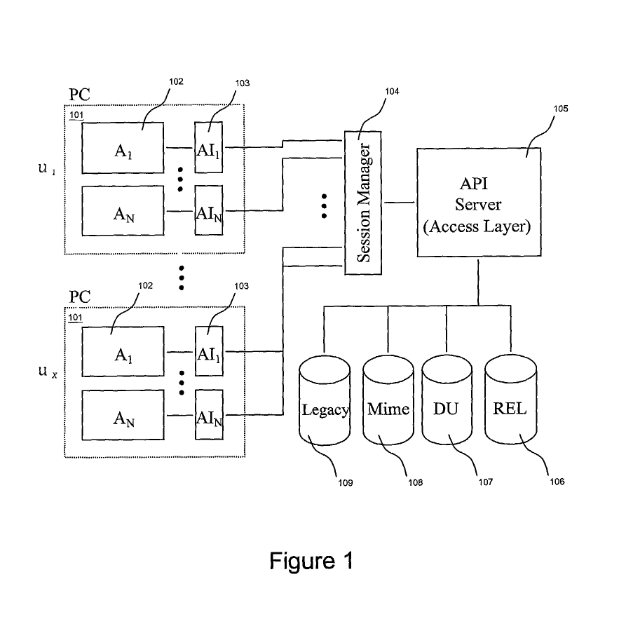

FIG. 1 is a block diagram of a Collaborative Knowledge Management System (CKMS) implementing the invention. The present embodiment of the CKMS comprises nine distinct components including a personal computer (PC) 101 having various application programs 102 and application interfaces 103; session manager 104, API server 105, relationships database 106, data units database 107, MIME (simulating application behavior and originally used for email as the Multipurpose Internet Mail Extensions), database 108, and a legacy database 109. Each of these components are described below. However, while the present embodiment of the invention includes the described division of functionality and storage facilities, other configurations and components may be used without departing from the spirit and scope of the invention. Thus, for example, multiple functions may be incorporated into a single platform, a single function may be distributed over multiple platforms, and certain optional and/or supporting functions and capacities may be eliminated to provide a partial CKMS capability according to the invention.

PC 101 is comprised of conventional personal computers including a motherboard that houses a processor, memory and interface to connect to peripheral devices, several peripheral devices such as a video driver card and a network card, integrated hard drives, monitor, keyboard and mouse. The PCs run computer applications including those that are enabled by the CKMS. Each of the PCs include a suite of software that runs on the PC and are connected with services available on the same computer. Examples of these applications are Microsoft Word, Microsoft PowerPoint, Microsoft Excel, Microsoft Outlook, Microsoft Project, Microsoft Organizational Map, Internet Explorer, Netscape Navigator, Mathwork Matlab, and others. The general terminology for these types of applications is a set of knowledge driven applications. Anything that either creates knowledge or consumes it would fall under this category. These applications are then linked together from a central server so as to centralize the small pockets of knowledge, provide relations to these applications to form a larger knowledge base and to be made available to the end users. Without this integration, the same application is a secluded knowledge repository. A communication link provides event and data transmission from the application to its server counterpart.

Application interfaces 103 implement the client portion of a client/server relationship. The event and data that are intercepted in applications 102 are passed to these units for local logic processing or remote server processing. This item is application specific and machine specific. Session manager 104 is used for flow control. The session manager is designed to handle several levels of activity and can reside on a single machine without sharing resources with any other process. Session manager 104 takes client messages and queues them appropriately to be processed by API server 105 and buffers server activity from the client side. API server 105 provides the server portion of the client/server relationship. API server 105 communicates in a universal language to session manager 104, which passes the message to application interface 103. API server 105 can reside on any machine type and be distributed on any number of machines. The API server implements the relationships that exist across database tables including access rights to all data, database search capabilities, and persistence services that signal or prompt clients for events.

Relationships Database 106, also called the object bank, contains relationships and pointers to actual data that resides in Data Units (DU) database 107 and MIME database 108. Thus, DU database 107 contains the data unit contents. The Data Units are the basic content elements of the system. More complicated content is built by aggregation of these units. These items are format free and contain only the simplest format specified by the system. The end user can view Data Units in any application that is enabled by the CKMS which are resident in the computer. MIME information is maintained in MIME database 108. These are the application specific data for the applications that do not have an associated interface specified. Arbitrary data produced by any arbitrary application can be attached as MIME data. The end user then has to make sure that the application is resident in the computer before viewing MIME data. Legacy database supports installation of the CKMS on an existing database platform that provides an array of services to its server counterparts.

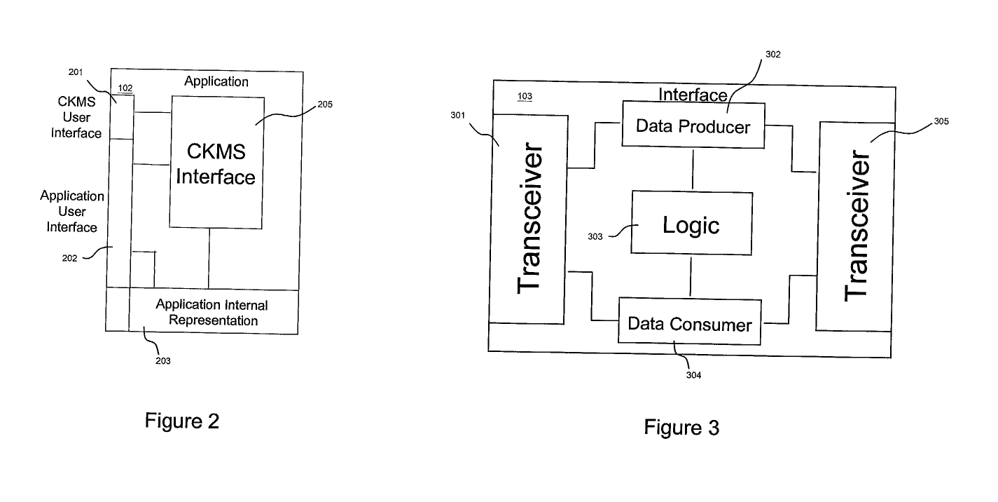

FIG. 2 is a block diagram showing details of application interface 103 used to gain access to the application events and data by routing some events through the interface 103 and driving the application's internal data representation. The underlying requirement is to provide access to events and internal data representation. Such access constitutes the capability of detecting and initiating application events, reading and writing internal application data, and converting internal application specific data to an alternative format. Application interface 103 includes CKMS user interface 201 which specifies the integration of a custom user interface inserted within the enabled application. User interface 201 contains CKMS related items such as “Save”, “Load”, “View attachments”, “Version Rollback,” among others. Application User Interface 202 specifies the existing user interface that the application uses. This set of user interfaces is actually a subset of the original user interfaces. Application internal representation module 203 specifies the application's local storage of intermediate data. This is the usable data that the application has either cached in local memory, has stored into the hard drive as virtual memory or stored in a temporary file. The representation of this data is application specific and interacts with the original application user interface. CKMS Interface 205 specifies the application interface and is designed to circumvent some or all of the user interface events and route the events and data via CKMS Interface 205 to the application client and the application internal representation. This enables detection and initiation of application events, read and write of the application's internal data representation. The application data is converted to and from an intermediate format (commonly available) that supports a universal representation within a repository. Thus, Interface 205 represents the communication to the application client integration. Events and data that need to be coordinated with the information repository are communicated via this link.

Application interface 103, as shown in greater detail in FIG. 3, is designed to offload the processing requirements outside of the main application. Processing requirements such as content translation, client/server messaging and event handling (application and server persistence events) can then be performed by Application Interface 103. Application Interface 103 transceiver module 301 separates incoming messages from outgoing messages. This transceiver module is designed to communicate at the application integration point, provide input to the data producer and take input from the data consumer. Data producer 302 uses data provided from transceiver module 301 along with available logic and produces data that is then transmitted to a server. The server messaging is universal and application independent. However, data producer 302 and consumer 304 are application dependent. Logic module 303 implements logic that has been off loaded from the application and server. It is available to data consumer 304 and data producer 302 as a service provider that enables a state machine for local caching and database services. Logic module 303 is application dependent. Data consumer 304 corresponds to or mirrors the functioning data producer 302 in that it takes the standard messages that are passed back and forth to the server and creates messages that are only application dependent. Data consumer 304 responds to logic module 303 to perform state dependent operations. Finally, transceiver 305 is similar to transceiver 301 in that it takes directional input/output from one side and operates a bidirectional data flow from the other side. The bidirectional side passes and receives universal messages that are application independent.

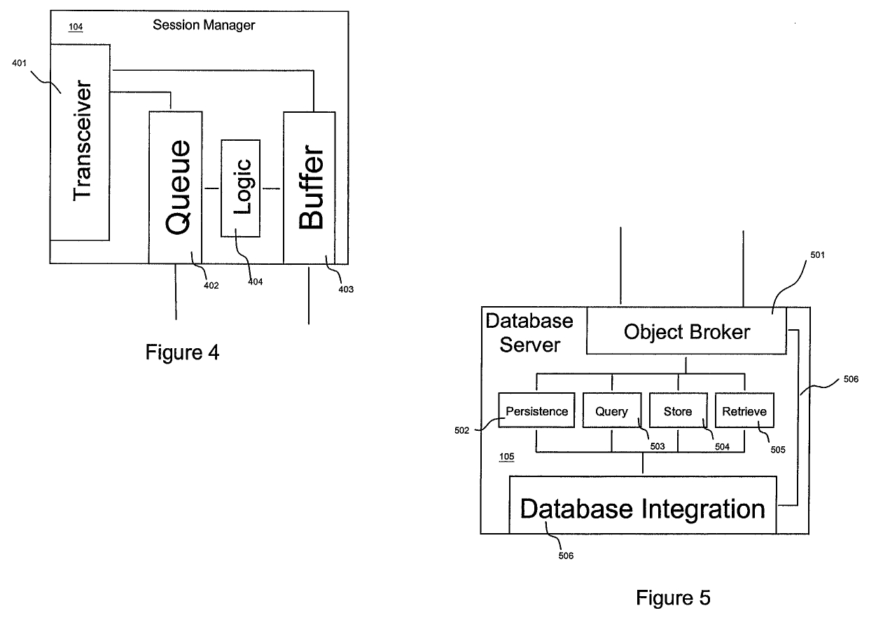

Session Manager 104, as shown in further detail in FIG. 4, is designed to interface with the multitude of clients that interface with the applications and provide a uniform connection to the server with well-defined input/output communication loads and distributable load balancing. Session Manager 104 also provides feedback for dropped, full or empty buffer/queue statistics. This component is designed to be light and scalable within a single shared memory machine and to take advantage of a multi-processor machine by using multi-threaded components. A match is made between the capabilities of the machine that this component uses and its server counterpart. For a single processor machine that houses the session manager and the server, a suitable resource allocation is implemented.

Session manager 104 includes transceiver 401 which takes the universal messaging that the application interface client uses and provides it to a memory storage unit for receiving data; and it also takes the universal messaging from a memory staging area when transmitting data. Queue module 402 uses a portion of memory to input server requests, taking incoming messages and lining them up for input to the server. Queue module 402 also has load-balancing characteristics along with feedback capabilities, via Logic 404, to signal the client if an incoming message was dropped due to a memory full error. The queue is designed with specific scalability in mind and is implemented with multi-tasking capabilities.

Buffer module 403 is the counterpart of queue module 402 and includes a portion of memory that takes input from the server and puts it in a buffer to be transmitted to the appropriate client. Similar to queue module 402, it has load-balancing characteristics, and feedback capabilities via Logic 404 to signal the server for a dropped message due to a memory full. Logic module 404 provides feedback to client or server and dynamic resource allocation if queue and buffer resources need to be modified for better overall resource consumption.

FIG. 5 is a detailed block diagram of session manager 104 as it is designed to provide universal server access. The server implements the specific data organizational model that allows efficient access to the relational data along with scalable features that enable growth. This server embodies features that can integrate multiple databases housed in different machines, manages different types of databases; and implements database search and relational content storage.

Database server 105 includes object broker 501 which implements specific routing functionalities of the server. Object broker 501 implements logical interaction between incoming objects and available resources. The object broker can implement a distributed system and allow efficient communication of these objects. The broker has the ability to push and pull data to all of the resources of the server unit including directly sending and receiving data from the database via an integration layer in database integration module 506, and the ability to implement other services not shown in the block diagram.

Persistence services module 502 provides the ability to push data and events to clients with a specific set of requirements. This service maintains a local database of active users and knowledge containers. It then integrates this information with object broker 501 to spawn a transmission of objects to clients. This functionality can be dependent on other components of the server.

Query module 503 generates query calls to the database at the request of object broker 501. This query is able to process client calls to database interaction. Storage is similar to retrieve module 505, as it allows the storage of content. This content can be any abstract content like a user defined string of characters or paragraphs in a MicroSoft Word document, emails from Outlook or third party application dependent MIME data. This functionality can be dependent on other components of the server.

Retrieve module 505 provides for the loading of content. This content is any abstract content like a user defined string of characters or paragraphs in a MicroSoft Word document, emails from MicroSoft Outlook and third party application dependent MIME data. This functionality can be dependent on other components of the server.

Database integration module 506 allows for table creation along with table traversal, query optimization and data retrieval. This provides a seamless layer to the database components. Any table optimization that allows specific query types needs to be implemented here. The functionality of the database as a special purpose filing system is abstracted away from the server in this component. Link 507 provides direct communication from object broker 501 to the database integration layer. This link allows for processing that is not denoted in persistence, query, store and retrieve modules 502-505 and allows brokering processes that need information stored in the database.

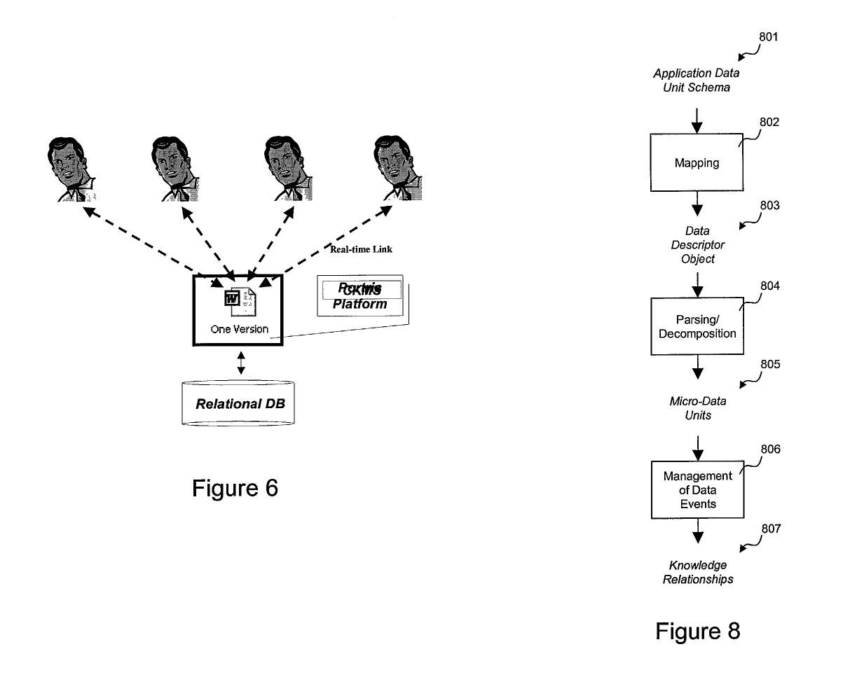

The CKMS allows large numbers of users to access a single information repository to edit, store, and retrieve content. Representation of the knowledge is managed for integrated applications and is stored as a central point of containment. A feature of this system is the built-in versioning where rather than exchanging via email copies of new versions, messages related to the process and the evolving work. All users connect directly to a CKMS Server as depicted in FIG. 6 and eliminate redundant message store via local store or network resources. An email that has an attachment will only contain a database pointer as a point of contact for its content container. Instead of mailing copies of files, a database pointer is sent, while still preserving user coherency in their knowledge work. Another feature of this system is the implementation of relationships in between the pockets of knowledge. The relationships convey context to the data units and further enhance the knowledge content within the pockets of knowledge. Therefore a structure emerges that allows a new knowledge management paradigm. The structure of knowledge then allows creation of tools that manage and automate the knowledge. Tools, which include but are not limited to browsing, searching, updating, record keeping and security enforcement can be built with this structure. The main relation types are those of containment and content attachment relation but could also contain other relational types. Any cross-referencable content uses a type of relationship that adds user capability. The type of relationship and its set of management tools dictate features and benefits of the relationship. Example of such a cross reference is implementation of a motivation-based content relation where the motive is captured in an relation and the edited/added/removed content is appropriately referenced by a relation object. Another example of cross referencing content, similar to the previous example, is to keep track of which edit/add/delete operations happened at the same time so that if an edit happened in a specific data unit there would be a quick navigate to other content within the same container that might be related. Yet another cross-reference relation is a decision logic relation. The decision logic relation is a specific relation object where not only does it reference content but also operates on the content to produce an output that is yet another content.

With the use of relationships that connect pockets of knowledge to form a large knowledge representation, the task of assembling and rendering knowledge query, search and visualization requests requires new and unique processing capability. The CKMS system provides an indexing mechanism that captures container contents, which hold content pointers that eventually resolve into Data Units, along with indices that support relation and data unit searches. Specifying a query in this climate allows for specification of containment and relationships along with traditional keyword query commands. The CKMS system provides such a query mechanism to support the specification of containment and relationships. The visualization of the knowledge network is done graphically to portray the knowledge network at any level of granularity (“zoom level”). If there exists a large number of matches, the zoom level needs to be low enough to capture the entire set of matches. This means that detail may be increased or decreased to accommodate the breadth and depth of the search results (i.e., number of matches). Any search may be narrowed (i.e., reduction in the number of search results) by introducing additional detail into the search parameters providing the ‘zoom-in’ effect, with the converse, ‘zoom-out’ effect, also being true.

The CKMS provides various functions tailored to specific applications. For example, saving a Microsoft Word document into the CKMS Server requires that, with a preexisting document open, the user clicks on the “File|Save As” using the CKMS enabled Microsoft Word menubar. With one click, the user selects the document to be saved into the CKMS, instead of on the local PC hard drive. Clicking Save, the document, at this point having been converted to CKMS Virtual Document, immediately becomes available to all other users within his/her team. Two or more users open the same Virtual Document at the same time in Microsoft Word, each subsequent team-mate opens the Virtual Document from the CKMS, using the CKMS enabled Word menu item “File|Open.” The same Virtual Document is now open (in read/write mode) by two or more users.

Simultaneously editing of a Virtual Document by two (or more) users is accomplished as follows. Initially, the first team member (“User A”) begins editing a section of a Virtual Document. The user does this by first selecting a region of text (e.g., several characters or paragraphs) and then clicking a button added by the CKMS interface labeled ‘Lock.’ Immediately, the same text in the second team member's Word Application (“User B”) graphically shows the event, showing that another user is editing the section (i.e., a newly created Data Unit). When user B decides to work on a different section (i.e., another Data Unit) of the Virtual Document, “user B locks” the section using the same procedure. Both users are now simultaneously editing the same Virtual Document. Thus, editing a given Virtual Document does not require that any given user be in a specific application or Virtual Document at the same time as the other users—rather, users can independently edit the same Virtual Document asynchronously. Synchronous collaboration only occurs as a random outcome of one or more users locking a Data Unit at the same time.

The previous example addresses a single application, Microsoft Word, and a specific content container (i.e., Virtual Document). The CKMS integrates with a general set of knowledge applications that work on a general set of content containers. For example presentations, as in Microsoft Powerpoint presentations, are another example of an application and content container while outlook and emails are another. The common denominator for all applications is content storage and management.

As previously described, the CKMS provides Real-time Exchange of Information (“XI”) so that, as many users begin to edit Data Units, the CKMS provides real-time updating, ensuring that all users are editing and reviewing the latest information. As users edit Data Units, save their changes (‘File|Save’) and “unlock” sections, the CKMS instantly shows all other users which relevant Data Units (that have been embedded in their Virtual Documents) have been changed, or simply updates their Data Units with the changes automatically. The procedure shows such outdated content graphically in real-time. When any user comes across a highlighted section (i.e., Data Unit) that contains graphical annotations simply clicking on the section prompts the CKMS to automatically push the latest content into a user's Virtual Document. Given that a Data Unit can be rendered into any CKMS enabled application and shared among numerous files (hundreds to thousands of times), the CKMS can instantly show a user in a CKMS enabled application, the changes that a user in another CKMS enabled application has made to a shared Data Unit.

A Virtual Document, being a collection of Data Units as created and organized by a user is not limited to the application it was created in nor is it stored as a discrete entity. As previously defined, a user could be humans using machines and the machines taking actions according to their programming routines. In particular, a user can be a computer software that controls a corpus of information for a group. The software then operates on the Data Units and manipulates content just like a human. Therefore, by interfacing to computer programs, implementing decision logic relations and threading of content for automatic updates, a high level programming language is provided that is well suited for large scale knowledge-based problems. Integration to some of the application programs is as easy as creating flat files and copying them to the information repository as a Data Unit or the level of integration may include the development of customized application program interfaces. The underlying computational model is further enabled by interface to programs that have computational capability and since there exists a single repository, the application's computational capability can be deployed on a large scale, instead of a single user and machine.

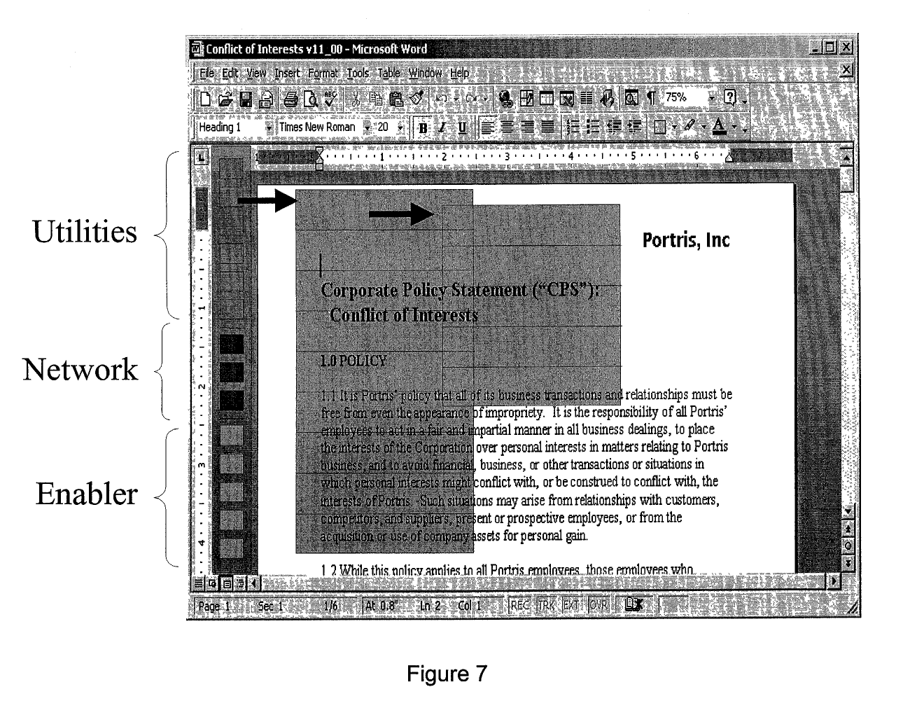

In an implementation accommodating or incorporating a Microsoft Word application, the user has access to a toolbar that allows triggering of CKMS supported events. Such an interface is shown in FIG. 7. In this figure the toolbar that appears on the left hand side triggers various mechanisms such as locking, updating or attaching content to the current content. The CKMS toolbar, which contains interface commands based on the general categories of Utilities, Network and Enabling tasks allows users to further specify command related information and utilizes full functionality of CKMS. This toolbar is constant across all applications and it is designed to follow users as they move from application to application.

Users open CKMS content containers via CKMS enabled applications. The containers are stored as entries in a database, making them multi-user accessible, scalable and manageable across wide networks. These containers, in their entirety are referenced via database entries and contain database entries only. These entries are pointers that refer to elements in other databases. The CKMS enabled applications open a container by signaling the server via application interface 103, session manager 104 and API server 105. API server 105 then accesses the database to retrieve the pointers contained in the Virtual Document. The server continues to retrieve the content associated with each pointer and sends them to the client by creating the appropriate object using object broker 501. Immediate content and relation resolution are performed by and within API server 105. The virtual file, which is used by the application as its internal data representation, is created by the client.

Users save the CKMS container via CKMS enabled applications. The save command first examines the changes made to the container. If the container was opened by the native open command, not the CKMS enabled method, then the entire document is treated as a change in one content. For each content element, the client tests the change state supported by logic 303. If a change has occurred, the client sends the change or the entire content (based on an efficient representation) to the server for storage of a newer version. The server detects the existence of a newer version and tags the older version with an updated flag. This will be used when opening another Virtual Document that includes the common Data Units. The flag then denotes the existence of newer content and the user is capable of allowing automatic update or user-approved updating.

The content lock capability supports sharing of Data Units by multiple users. When one user changes content, the CKMS client intercepts the event, sends the event to the application's internal representation and signals the server that the content is being edited. Only a pointer represents the content, hence the server signal consists of the pointer and the event that the content is being edited. The server then flags the content as being edited in a specified Virtual Document. The persistence services then pushes a lock event to all other clients that have the same Data Unit open at the same time. All other clients that have opened a container with the specific Data Unit then receive the lock event, which signals the application to lock the associated content.

Content security is implemented with basic security (Read, Write, Copy), which can be backed into organizational models. There are default settings for security implementation of the Read, Write and Copy fields. Integration of these settings into an application needs only the Read, Write and Copy attributes. The calculation of the Read, Write and Copy attribute is dependent on the user and content profile. When the user alters these settings, it propagates the event, based on its own profile. If the user wants to change the setting for a current Data Unit, or group of Data Units, the client provides a dialog box that depends on the current security settings of the content and security level of the user. If the user has only Read privileges then it can only change that attribute. If the user has to change an attribute that it has no privilege to alter, then the user needs to be the author or have an authority that exceeds the security setting of the content. This is done by keeping a database of users security levels and content security settings along with the ability to distribute time-limited, task-based and user/group concentric changes in security. The client then transfers the user identity and the pertinent security protocol to the server, which then analyzes the data security database along with user and content profiles. The server then releases content with associated attributes. For access denied content, nothing is transferred. The rest of the security is implemented as a user interface on the client side along with fallback methods from the server side. For example, if a user wants to edit a read-only content, then the client signals appropriately. If for some reason the authority to edit was changed on the client, the server denies version updating.

Multiple users sharing a Virtual Document require implementation of a content update functionality supported by the CKMS. When one user saves a Virtual Document, the client interface compares the content of the Virtual Document with the previously opened Virtual Document and determines which Data Units have been changed. The Data Units that have changed are then transferred to the server to be stored as new versions, saved internally in the interface as a previously opened Virtual Document and signaled to the server to perform persistence operation to other clients using this content. API server 105 (FIG. 1) flags the containers that have include in them the Data Units to show existence of new versions and pushes events to clients that have these Data Units embedded in their Virtual Documents to notify the users of the existence of a new Data Unit version. For containers that are flagged, the client retrieves the persistence events and provides an interface to the user to update the content.

Version rollback functionality supports a user working on a specific Data Unit who wants to see the versions leading up to the current version of the content. The user initiates an event and the CKMS interface 204 (FIG. 2) traps that event, sends a message to the API server 105 that gets decomposed and which, in turn, uses the retrieve functionality of the database server and retrieves the content of the previous version. The content is then formed into a message in the object broker 501 and sent to the CKMS interface 204, where the interface sends the appropriate event and content to the application's internal representation.

Content partition supports dividing an object, such as a document, into several portions and, if desired, joining discrete portions into a whole. Thus, if a user is working on a Virtual Document and decides to partition content, the user selects a section (i.e., Data Unit) of content and presses a button on the toolbar. If the selection contains multiple sections, then the client signals to the user that this is the case. If the user accepts, then multiple sections are partitioned and the remaining content is joined. The client sends a signal to the server, which then creates new Data Units along with appropriate relational pointers that signify the operation. The affected content is then available for tagging to other users and eligible Virtual Documents that use the content.

Notes and comments may be created and associated with an object such as a document or Virtual Document. The user initiates a note by activating an attach button that is provided with a list of attachable content. The allowable attachments include but are not limited to Data Units, Microsoft Word documents, Microsoft Excel spreadsheets, database forms, Microsoft Powerpoint presentations, emails, notes (notepad), calendars, tasks, projects and MIME data. For all attachments, except for MIME-data, the CKMS system intervenes in either front office (CKMS Enabled Applications) or the back office (email, task, general ledger, enterprise resource planning ERP and others). The MIME-types are attached on a per file basis and use the file extension as registration to an application. For Front office attachment a browser retrieves the specified content (via a database pointer) and attaches it as an attachment to a Data Unit. For back office, the client signals the server that a back office event is requested where the server creates an event for the back office system. The back office then spawns the event and allows the server to capture that event and store relevant information as an attachment to the Data Unit via a relationship. The MIME-data attachment is a simple data download to the server. The server stores the data in the MIME-bank and compares the MIME-type with the registered MIME-types. If a new MIME-type is encountered, then an email is generated for the administrator signaling the user of this event. The purpose is that the administrator will contact the MIME-data generator for a copy of installation disks that allows conversion or viewing of the data.

Mapping Application Data Units into the CKMS Information Model is an important aspect of the invention. The CKMS forces a structure to unstructured data by abstracting user interaction and content which is also abstracted by raw data and data description. Modeled objects that handle the events and data in the CKMS fall under data objects, relation objects, MIME objects and profile objects. Data objects contain raw data along with data description. Relational objects vary in type and tie data objects together along with any other MIME data. MIME objects carry raw application dependent data that are associated with computer resident program applications. Profile objects contain all data that does not contribute to content but captures all other relevant information.

An application data, which describes presentation, functional and state of the program, can be easily abstracted into functional objects. These application dependent data can be converted into a universal format via a standard intermediate format. Use of a standard format such as the extensible Markup Language (XML) can provide the step to a universal conversion. Translation of data into an intermediate format can be done but is not limited to the use of the XML standard format. The functional objects of the application data are represented in an XML and its tags used to drive functionalities of the CKMS. The XML code is decomposed into data, relation, MIME and profile objects and stored in the appropriate data banks. The creation of these objects are based on application data and user interaction. The objects are created and related to each other so that the underlying knowledge is captured. The implied knowledge is held within that content and their relationships.

Functionally, as shown in FIG. 8 the CKMS maps the application Data Unit schema into Data Descriptor objects. The CKMS subsequently harnesses the application-provided Data Unit parser to decompose the application Data Unit into various collections of micro-data-units. These micro-data-units are managed as data elements, and connected to form a representation of the knowledge relationships.

By decoupling relationship objects from information and data objects, the CKMS enables the logical assemblage and association of information (via relationships) to transcend the application layer. As independent entities, relationship objects may connect and construct information objects across a disparate array of application Data Units and sources of structured information.

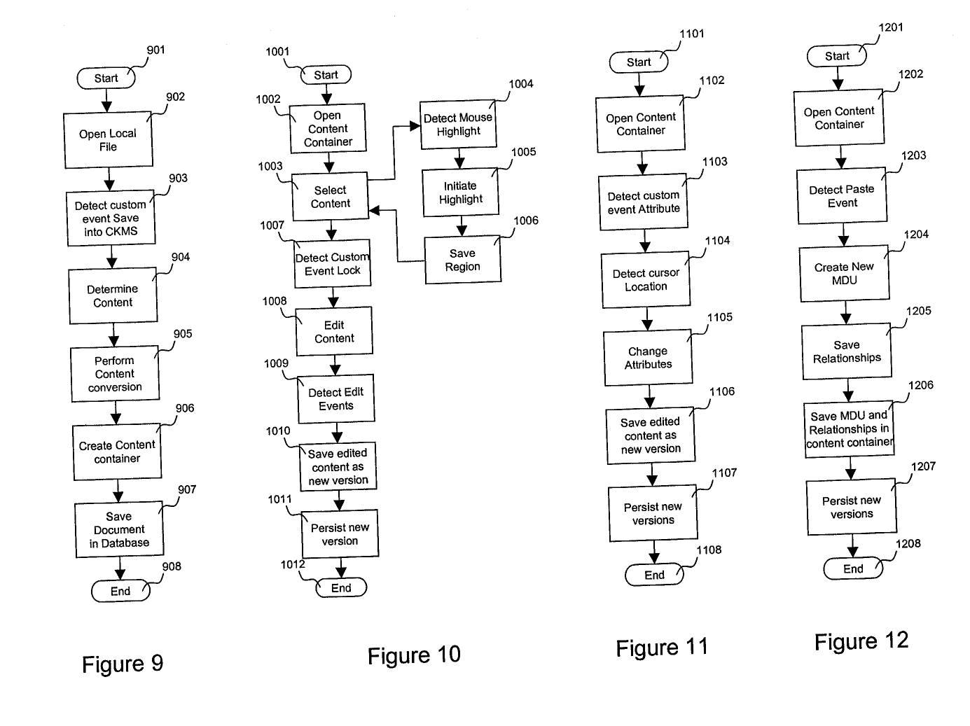

FIG. 9 is a flow diagram showing a method of saving a disk file into the CKMS. Step 902 causes a local file to be opened so that at step 903, a custom event is detected and saved into the CKMS. At step 904 a determination is made of the content of the event so that at step 905, content conversion is performed. Step 906 creates an appropriate content container which, at step 907, is saved in the database, the process terminating at step 908.

FIG. 10 is a flow diagram of steps required to edit a CKMS container. At step 1002 the content container is open and the appropriate content is selected at step 1003. Content is selected by first, detecting a mouse highlighted at step 1004, initiating a highlight action at 1005 and saving the indicated region at step 1006. A custom event lock is detected at step 1007 so that content may be edited at step 1008. Step 1009 detects editing events such that at step 1010, the edited content is saved as a new version. This new version is saved at step 1011, the process terminating at step 1012.

FIG. 11 is a flow diagram of a process for editing a CKMS container. Accordingly, at step 1102, the content container is open and, at step 1103, custom event attributes are detected. At step 1104, cursor location is detected so that at, step 1105, attribute changes can be performed, the edited content being saved as a new version at step 1106. The new version is saved at step 1107, the process terminating at step 1108.

FIG. 12 is a flow diagram of steps required to add a CKMS container. At step 1202, a content container is open and, at step 1203, a paste event is detected. A new MDU is created at step 1204 and, at step 1205 the relationships are saved. Step 1206 performs a save of the MDU in relationships in the content container, with a new version of the document saved at step 1207, the process terminating at step 1208.

While the foregoing has described what are considered to be preferred embodiments of the invention, it is understood that various modifications may be made therein and that the invention may be implemented in various forms and embodiments, and that it may be applied in numerous applications, only some of which have been described herein. It is intended by the following claims to claim all such modifications and variations which fall within the true scope of the invention.

It should further be noted and understood that all publications, patents and patent applications mentioned in this specification are indicative of the level of skill of those skilled in the art to which the invention pertains. All publications, patents and patent applications are herein incorporated by reference to the same extent as if each individual publication patent or patent application was specifically and individually indicated to be incorporated by reference in its entirety.

What is claimed is:

1. A collaboration and knowledge management system comprising:
an application interface configured to identify a data object selected by an application program;
a session manager configured to receive and buffer said data object; a server connected to said session manager and configured to define a set of relationships associated with said data object and associate said relationships with a set of rules defining corresponding user privileges associated with said data object;
a first database configured to store and retrieve said object and said set of relationships, said first database including a plurality of data stores including (i) a Data Units database storing basic unformatted content elements, (ii) a relationship database storing said set of relationships associated with one of said unformatted content elements, and (iii) a Profile Database storing usage history and associated metadata of said data; and
a client workstation executing said application program, said application interface and a remote server platform providing said server.

2. The collaboration and knowledge management system according to claim 1 wherein said data stores of said first database further includes (iv) a legacy database storing uncoded data.

3. The collaboration and knowledge management system according to claim 1 wherein said data stores of said first database further includes (iv) a MIME database storing arbitrary data in a MIME data type.

4. The collaboration and knowledge management system according to claim 1 wherein said data stores of said first database further includes (iv) a MIME database storing arbitrary data in a MIME data type and (v) a legacy database storing uncoded data.

5. The collaboration and knowledge management system according to claim 1 wherein said application interface, session manager, API server and Database collectively include a plurality of networked hardware configurations.

6. The collaboration and knowledge management system according to claim 1 wherein said application interface, session manager, API server and Database collectively include a plurality of local hardware configurations.

7. A collaboration and knowledge management system comprising:
an application interface configured to identify a data object selected by an application program;
a session manager configured to receive and buffer said data object;
a server connected to said session manager and configured to define a set of relationships associated with said data object and associate said relationships with a set of rules defining corresponding user privileges associated with said data object;
a first database configured to store and retrieve said object and said set of relationships, said first database including format conversion logic configured to reformat said data object between an application specific format and a predetermined markup language format; and
a client workstation executing said application program, said application interface and a remote server platform providing said server.

8. A collaboration and knowledge management system comprising:
an application interface configured to identify a data object selected by an application program;
a session manager configured to receive and buffer said data object;
a server connected to said session manager and configured to define a set of relationships associated with said data object and associate said relationships with a set of rules defining corresponding user privileges associated with said data object;
a first database configured to store and retrieve said object and said set of relationships, said first database configured to process said data object into an intermediate format and save said data object in a universal representation; and
a client workstation executing said application program, said application interface and a remote server platform providing said server.

9. A method of storing knowledge comprising the steps of: circumventing application events and application data to form pockets of knowledge, said step of circumventing including
(i) converting said application data into a standard format,
(ii) detecting said application events,
(iii) initiating said application events,
(iv) reading said application data, and
(v) writing said application data;
storing said pockets of knowledge in an information repository including writing said pockets of knowledge into a database while preserving a knowledge structure of said pockets of knowledge; and
providing access to said pockets of knowledge stored in said information repository to a plurality of applications including
(i) converting pockets of knowledge from a standard format into said application data, and
(ii) converting pockets of knowledge from a standard format into said application events.
